(19) United States
(12) Patent Application Publication
(10) Pub. No.: US 2026/0264926 A1
(43) Pub. Date: Sep. 10, 2026

(54) Dual Dispenser Apparatus for Breath Freshening and Dental Care and Related Methods

(71) Applicants: Daniel Hughes, Decatur, GA (US); Craig Taylor, Decatur, CA (US)

(72) Inventors: Daniel Hughes, Decatur, GA (US); Craig Taylor, Decatur, CA (US)

(21) Appl. No.: 19/074,655

(22) Filed: Mar. 10, 2025

(51) Int. Cl. B65D 5/72; A61C 15/04; B65D 5/38; B65D 65/46; B65D 83/04

(52) U.S. Cl. CPC B65D 5/728; A61C 15/043; B65D 5/38; B65D 65/466; B65D 83/04

(57) ABSTRACT

A dual purpose biodegradable dispenser is designed to freshen breath with mints and enhance smiles with dental floss, The dispenser is intended for a 7-day use period and is biodegradable. It features a dual access mechanism with a locking system that allows access from both sides, ensuring controlled dispensing of mints and floss. The design prevents the tray from passing completely through either side, maintaining organized access to the contents.

### TECHNICAL FIELD

The invention relates to a dual-purpose dispenser for oral hygiene, combining mints and dental floss in a single biodegradable unit with a unique locking mechanism.

### BACKGROUND

Oral hygiene is an essential aspect of personal health, with a significant impact on overall well-being. Maintaining fresh breath and a clean smile is not only important for personal confidence but also for preventing dental issues such as cavities, gum disease, and bad breath, Traditionally, individuals have relied on separate products such as mints or chewing gum for freshening breath and dental floss for cleaning between teeth. However, carrying multiple products can be inconvenient, especially for those with busy lifestyles or limited space in bags or pockets.

In recent years, there has been a growing demand for more sustainable and environmentally friendly products. Consumers are increasingly aware of the environmental impact of single-use plastics and non-biodegradable materials commonly used in packaging. This has led to a push for innovative solutions that combine functionality with sustainability, The challenge lies in creating products that not only meet the practical needs of users but also align with their environmental values, offering convenience without compromising on ecological responsibility.

### SUMMARY

In accordance with embodiments, a dual-purpose biodegradable dispenser is provided. comprising a dispenser apparatus that serves to freshen breath with mints and freshen smile with dental floss. The dispenser apparatus is designed to be useful for 7 days and is biodegradable. It includes a dual access dispenser with a locking mechanism that is designed to open on both sides to access the mints and floss, and prevents a tray from going all the way through either side, providing controlled access to the mints and floss.

In accordance with other embodiments, the dual purpose biodegradable dispenser comprises a dual dispenser product in one, as described in claim 2, In yet other embodiments, the dual access dispenser with locking mechanism comprises dual sided openings with the locking tray, as described in claim 3.

Further embodiments include the dual sided openings that open on both sides, as described in claim 4.

Additional embodiments include the locking tray that does not go all the way through either side, as described in claim 5.

In accordance with yet another embodiment, a method of providing a dual purpose biodegradable dispenser is provided. The method comprises providing a dispenser apparatus that serves to freshen breath with mints and freshen smile with dental floss, wherein the dispenser apparatus is designed to be useful for 7 days and is biodegradable. It also includes providing a dual access dispenser with a locking mechanism that is designed to open on both sides to access the mints and floss, and prevents a tray from going all the way through either side, providing controlled access to the mints and floss, as described in claim 6.

In accordance with further embodiments, the method includes providing the dispenser apparatus as a dual dispenser product in one, as described in claim 7.

In yet another embodiment, the method includes providing the dual access dispenser with locking mechanism comprising dual sided openings with the locking tray, as described in claim 8.

Further embodiments of the method include providing the dual sided openings that open on both sides, as described in claim 9.

Additional embodiments of the method include providing the locking tray that does not go all the way through either side, as described in claim 10.

### BRIEF DESCRIPTION OF THE DRAWINGS

FIG. 1 illustrates a perspective view of the outer container for the dual-purpose dispenser for mints and dental floss, in accordance with at least one embodiment.

FIG. 2 illustrates a side view dual-purpose dispenser for mints and floss, in accordance with at least one embodiment.

FIG. 3 illustrates a top-view of the outer container for the dual-purpose dispenser with a locking mechanism, in accordance with at least one embodiment.

FIG. 4 illustrates a top perspective-view of the inner locking tray for the dual-purpose dispenser with a storage compartment.

FIG. 5 illustrates a bottom view of the outer container while not assembled.

FIG. 6 illustrates a bottom view of the inner locking tray while not assembled.

FIG. 7 illustrates a flowchart for utilizing the dual-purpose dispenser in accordance with at least one embodiment.

### DETAILED DESCRIPTION

The terms “a” or “an”, as used herein, are defined as one, or more than one. The term “plurality”, as used herein, is defined as two, or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an exemplary embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Materials described or referenced herein will sometimes be described in singular form for clarity. However, it should be appreciated that particular embodiments may include multiple instantiations of a material unless noted otherwise. Surfaces in some embodiments can be understood as representing segments or portions of those embodiments. Alternate implementations are included within the scope of embodiments of the present invention would be understood by those having ordinary skill in the art.

Headings of sections provided in this patent application and the title of this patent application are for convenience only and are not to be taken as limiting the disclosure in any way. A description of an embodiment with several components in connection with each other does not imply that all such components are required.

Turning now to FIG. 1, depicts the outer container of the dispenser 1 of a dual-purpose dispenser product in one, which combines the outer container and an inner locking tray within a single unit. The single unit serves to store mints and dental floss in a singular unit utilizing a first storage compartment and a second storage compartment. This dual functionality is achieved through the integration of edible mints and dental floss into the apparatus, allowing it to serve both purposes simultaneously. In a non-limiting example, the apparatus is designed to be useful for a duration of about seven days, emphasizing its limited usage duration, and it is biodegradable, highlighting its environmental friendliness. This design consideration ensures that the apparatus is not only functional but also sustainable, aligning with modern environmental standards. The dual dispenser product combines convenience with ecological responsibility, providing users with a practical and eco-friendly option for oral hygiene. The dual sided openings (2a,2b) are integral to this functionality, ensuring that the dispenser can be accessed from both ends, thereby enhancing user convenience. The illustration further shows a fainted view of a locking mechanism 3 that is positioned within the internal section of the outer container 1.

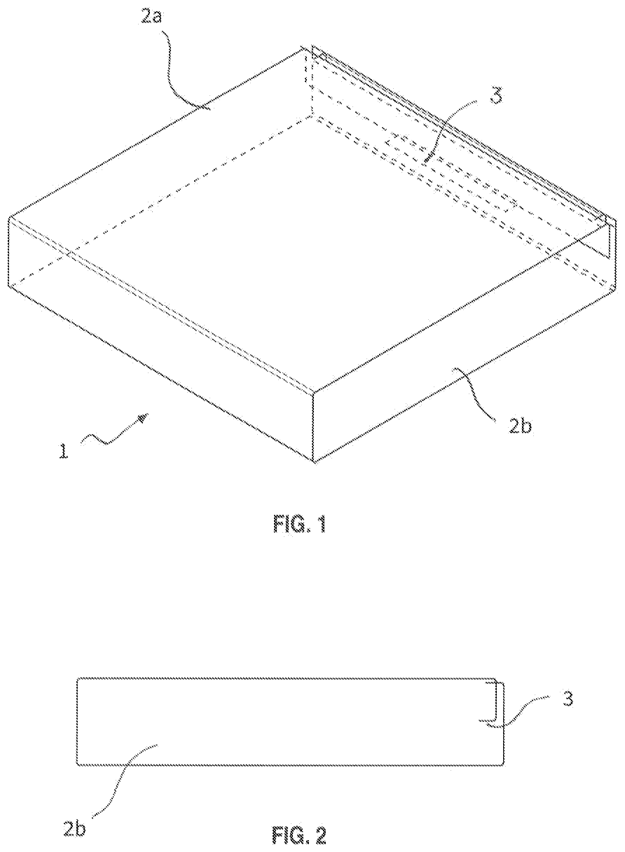

Turning now to FIG. 2, depicts a side-view of the outer container of the dispenser 1 to fully depict the location of the locking mechanism 3 that engages within a slot 5 located on the inner locking tray 4. While assembling the apparatus, the outer container 1 is intended to fully wrap around the inner locking tray 4 allowing the user to insert the locking mechanism 3 into the slot 5 of the inner locking tray 4. Subsequently, the locking mechanism 3 plays a role in preventing the inner locking tray 4 from traversing completely through either side of the dispenser. This mechanism provides controlled access to the contents, ensuring that the mints and floss are securely held within the dispenser and are dispensed in a controlled manner, The locking mechanism 3, as part of the embodiment, is designed to halt the inner tray's movement, thereby preventing it from passing entirely through the outer container 1. This feature not only secures the contents but also maintains the structural integrity of the apparatus during use. Furthermore, the provision of dual sided openings (2a, 2b) with the locking mechanism 3 is a component of this step. It will be appreciated that while the dispenser is accessible from both sides, the locking mechanism 3 effectively manages the movement of the inner locking tray 4, thereby preventing any unintended spillage or loss of contents. This design consideration underscores the importance of secure access, which is a fundamental aspect of the dispenser's functionality.

Turning now to FIG. 3, depicts a top-view of the outer container 1 as assembled that illustrates the location of locking mechanism 3 positioned internal to the outer container 1.

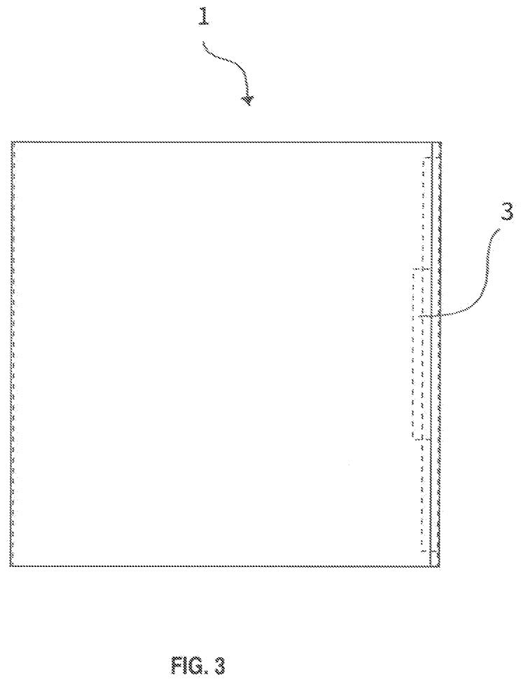

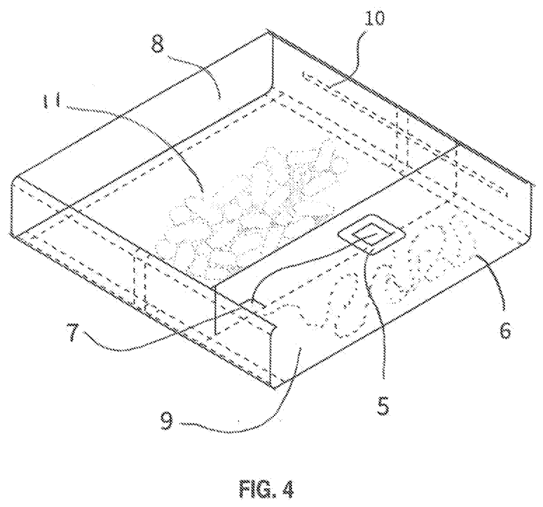

Turning now to FIG. 4, depicts the top-perspective view of the inner locking tray 4 removed from the outer container 1 to show the location of a cutter apparatus 5 that is used to sever floss 6 while being pulled through a hole 7 for dispersing the floss 6. The illustration further depicts a first compartment 8 for storing mints 11. In use the inner locking tray 4 will be locked inside of the outer container 1 by inserting the locking mechanism 3 into a slot 10 located along the side wall of the first compartment 8. There is a second compartment 9 below the cutter apparatus that holds the floss 6. The depiction further displays how the floss 6 is located within the second compartment below the cutter apparatus 5. A hole 7 as shown illustrates how the floss 6 is pulled from the second compartment 9. The depiction further shows the location of the slot 10 where the locking mechanism 3 would be inserted during assembly of the apparatus in a manner to restrict the movement of the inner locking tray 4 during use. The restriction of inner tray allows a user to open the tray at a distance to dispense the mints 11.

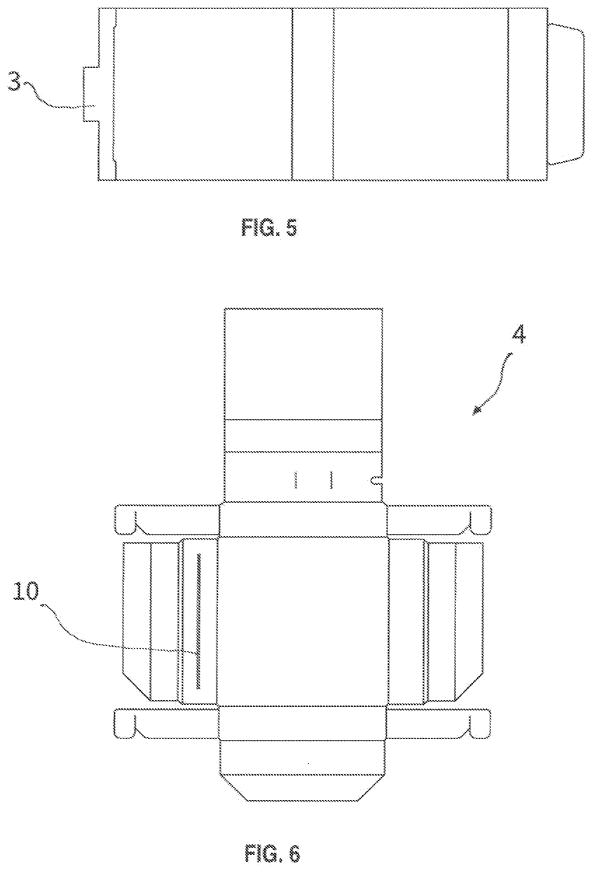

Turning now to FIG. 5, which depicts a bottom view of the outer container 1 that is not assembled to illustrate the geometry of the container and the location of the locking mechanism 3.

Turning now to FIG. 6, which depicts a bottom view of the inner locking tray 4 that is not assembled to illustrate the geometry pf the inner locking tray 4 and the location of the slot 10 for receiving the locking mechanism 3.

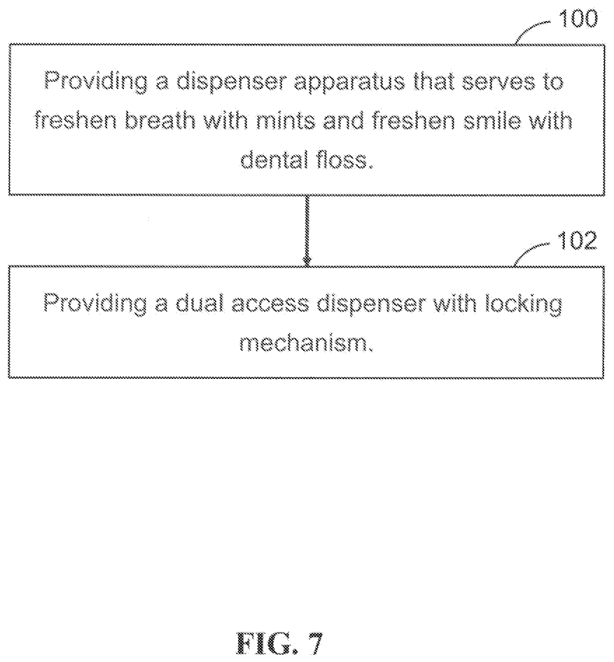

Turning now to FIG. 7, is a flowchart for utilizing the apparatus, in step 100, the process involves providing a dispenser apparatus that serves dual purposes: to freshen breath with mints and to freshen a smile with dental floss. This step is further elaborated through sub-steps that detail the design and functionality of the dispenser apparatus.

In step 102, the process involves providing a dual access dispenser with a locking mechanism. This step is further elaborated through several sub-steps. Initially, the dual access dispenser is designed to open on both sides to facilitate access to the mints and floss. This design feature embodies the accessibility aspect of the dispenser, allowing users to conveniently retrieve either mints or floss from either side of the apparatus.

Overall, step 102, with its associated sub-steps, exemplifies the intricate design and functionality of the dual access dispenser with a locking mechanism. The embodiment of these features ensures that the dispenser not only provides easy access to its contents but also maintains a level of security and control, thereby enhancing the user experience.

In various embodiments, the dual-purpose biodegradable dispenser is designed to serve multiple functions, primarily focusing on oral hygiene. The dispenser apparatus, which is a dual dispenser product, is crafted to freshen breath with edible mints and simultaneously freshen the smile with dental floss. This dual functionality is achieved through a combination product that integrates both mints and floss within a single apparatus. The apparatus is described as being useful for a duration of 7 days, emphasizing its limited usage duration, and is also biodegradable, highlighting its environmental friendliness.

The dispenser apparatus is further characterized by its dual access design, which includes a locking mechanism. This mechanism is pivotal in ensuring controlled access to the mints and floss. The dual access dispenser is designed to open on both sides, allowing users to access either the mints or the floss as needed.

The integration of these features within the dispenser apparatus exemplifies a thoughtful approach to combining convenience with sustainability. The dual dispenser product not only serves the practical purpose of oral hygiene maintenance but also aligns with environmental considerations through its biodegradable material. The locking mechanism and dual access design further enhance the user experience by offering ease of use while maintaining the integrity of the product's contents.

In a non-limiting example, the dispenser apparatus, which is a dual dispenser product, serves a dual purpose: freshening breath with mints and enhancing smiles with dental floss. This dual functionality is encapsulated in a single apparatus, making it a combination product that is both efficient and convenient for users. The biodegradability of the dispenser apparatus is a feature, aligning with modern environmental concerns and ensuring that the product does not contribute to long-term waste. The limited usage duration is a deliberate design choice, ensuring that the product is used within a specific timeframe, which complements its biodegradable nature. This design not only serves the immediate needs of the user but also considers the broader impact on the environment, making it a responsible choice for consumers.

The dispenser apparatus, in this context, is equipped with a locking mechanism that plays a role in maintaining controlled access. The locking mechanism, along with the tray, is engineered to provide secure access, preventing any unintended spillage or loss of the mints and floss. This design feature exemplifies the embodiment of controlled access, where the locking mechanism and tray work in tandem to maintain the integrity of the dispenser's contents.

The dual access dispenser, with its locking mechanism, exemplifies a secure access system that is both innovative and practical. This design not only enhances the user experience by providing easy access to the mints and floss but also ensures that the dispenser remains functional and reliable throughout its intended usage period.

While the present invention has been described above in terms of specific embodiments for purposes of illustration, it is to be understood that the invention is not limited to these disclosed embodiments. Likewise, while “the invention” or “present invention” may have been referred to at the times in this disclosure those terms are not intended to limit the scope of this disclosure or to suggest in any way that there is a single version or embodiment. While the invention relates generally to a cuboidal sensor for in-line measurement of tension and compression forces, inventive concepts that fall within the scope of this disclosure may include a variety of optional features, which do not need to be present in every version or embodiment. Various modifications and changes can be made without departing from the spirit of the invention. In fact, modifications and other embodiments of the invention will also come to mind of those skilled in the art to which this invention pertains, and which are intended to be and are covered by both this disclosure and the appended claims. It is indeed intended that the scope should be determined by proper interpretation and construction of the appended claims and their legal equivalents, as understood by those skilled in the art relying upon the disclosure in this specification and the attached drawings.

The skilled person will be aware of a range of possible modifications of the various embodiments described above. Accordingly, the present invention is defined by the claims and their equivalents.

What is claimed is:

1. A dual purpose biodegradable dispenser comprising:
a dispenser apparatus that serves to freshen breath with mints and freshen smile with dental floss, wherein the dispenser apparatus is designed to be useful for seven days and is biodegradable; and
a dual access dispenser with locking mechanism that is designed to open on both sides to access the mints and floss, and prevents an inner locking tray from going all the way through either side of an outer container, providing controlled access to the mints and floss.

2. The dual purpose biodegradable dispenser of claim 1, wherein the dispenser apparatus comprises a dual dispenser product in one; wherein the dual purpose dispenser comprises, the outer container and the inner locking tray.

3. The dual purpose biodegradable dispenser of claim 1, wherein the dual access dispenser with locking mechanism comprises dual sided openings with the inner locking tray.

4. The dual purpose biodegradable dispenser of claim 3, wherein the dual purpose dispenser openings on both sides.

5. The dual purpose biodegradable dispenser of claim 3, wherein the inner locking tray does not go all the way through either side.

6. A method of providing a dual purpose biodegradable dispenser, the method comprising:
providing a dispenser apparatus that serves to freshen breath with mints and freshen smile with dental floss, wherein the dispenser apparatus is designed to be useful for seven days and is biodegradable; and
providing a dual access dispenser with locking mechanism that is designed to open on both sides to access the mints and floss, and prevents an inner locking tray from going all the way through either side, providing controlled access to the mints and floss.

7. The method of claim 6, wherein providing the dispenser apparatus comprises providing a dual dispenser product in one.

8. The method of claim 6, wherein providing the dual access dispenser with locking mechanism comprises providing dual sided openings with the inner locking tray.

9. The method of claim 8, wherein providing the dual sided openings comprises providing openings that open on both sides.

10. The method of claim 8, wherein providing the inner locking tray comprises providing a tray that does not go all the way through either side.
